(19) United States
(12) Patent Application Publication
(10) Pub. No.: US 2003/0004989 A1
(43) Pub. Date: Jan. 2, 2003

(54) Computer device, method and software product for filling printouts by computer

(76) Inventor: Roland Tomasi, Merenvielle (FR)

Correspondence Address: YOUNG & THOMPSON, 745 SOUTH 23RD STREET 2ND FLOOR, ARLINGTON, VA, 22202

(21) Appl. No.: 10/168,627

(22) PCT Filed: Dec. 21, 2000
(86) PCT No.: PCT/FR00/03643

(30) Foreign Application Priority Data
Dec. 23, 1999 (FR) 99.16419

(51) Int. Cl. G06F 15/00

(52) U.S. Cl. 707/507

(57) ABSTRACT

The invention concerns a computer device and a method for filling by computer printouts comprising marks and wherein the characters need to be input Said device is adapted to enable storing and displaying on an electronic display screen an image, called initial image (12), representing a printout to be filled; automatically identifying the marks in the initial image (12); enabling said image (12) to be opened in at least one input window (20); then automatically identifying, in each input window, each of the portions of the initial image, called invariable graphic portions (M1), corresponding to marks extending in the input window (20), but having at least a dimension greater that a predetermined value.

The invention concerns a device, a method and a software product for the automated filling of printed documents that contain marks—among which usually are frames, lines, borders, columns, patterns, markers, graphical signs, alphanumerical signs . . . —and onto which characters are to be inserted and/or modifies and/or erased.

Even though the constant development of computer and communication technologies that results in a reduction of support materials like paper in industrial, commercial or administrative correspondence, there does not yet exist a considerable amount of situations where one cannot exclude the use of printed documents that have to be filled. Such printed documents may be forms, directories, tables . . . which have to be completed by inscription and/or modification of characters within certain predefined zones of the printed document, allowing thereby to deliver information and, in certain cases, to facilitate further computer processing. An example for such a printed document one can cite responses to calls to tender; the forms provided by administrations for the execution of formalities, for tax-payment, assets, rights or documents; le printed contracts for assurance or car-selling . . .

In order to solve this problem some organizations have developed specific programs that reproduces a specific printed document and enables the filling of its edition-fields with a computer. Those programs may be provided under the form of software products shipped on storage-media (loadable to a computer) or via a network similar to the Internet.

Furthermore each specific program is dedicated to the usage of a particular printed document and requires a relatively high cost of development. And there does not exist numerous situations yet where such programs are available, and/or important variations can be encountered from one printed document to another.

In the case of calls to tender for example there may not exist a universal printed document. The inverse is true, a specific printed document is created for each call to tender by the government or the collectivity corresponding to the charge book of this call to tender Therefore, in any situation where people have to fill printed documents (which means at least certain of their zones by variable characters), have to do this filling manually, with aid of traditional typing machines, or by collage of images (graphics, plans, photographs, etc.).

Additionally, before the filling of certain zones can be realized, it is necessary to do information processing (like calculation, text or image layout,).

All these operations are long, in some cases relatively complex, in other cases they are highly repetitive and annoying, while always a considerable cost of manpower. They force the users to maintain methods and tools which are now out-dated, slowing the integration of information-technologies in the companies.

Throughout the following text these terminologies are used:

Character: all graphical symbol, including alphanumerical characters, paintings, maps, patters, images, photographs, signatures, manual writings, fingerprints, codes for optoelectronical reading (bar-codes for example),

Editing a character: writing and/or modifying and/or erasing a character in a zone of a printed document,

Filling of a printed document: the fact of modifying at least one pixel in at least one zone of a numeric image of a printed document, usually to introduce signs or characters, to erase signs or characters, to replace signs or characters by others, or more generally to edit one or more characters.

Automated: the fact of executing one step or one function by means of information-technology and under their own control without requiring continued human guidance, even if one or more isolated actions of the human operator may be required at start-up or during execution of the step or function,

Identifying a mark: applying means to each subset of an image representing this mark that allow to select it in the image, to link it with an identification-code which is common for each of this subsets, and to save these information's on mass-storage memory, or in a volatile way in random access memory for use during processing.

Therefore the invention aims at giving a solution to the above-mentioned problem and at providing a information-technology device and method, a procedure and a software product (computer program) that allows the automated filling with the aid of a computer of any printed document, which means apply able in general manner to any printed document without need of configuration operations, complex development or longer programming.

Hence the invention aims at proposal of an information-technology device and method, a procedure, and a software-product for computer-aided filling of printed documents, universally apply able and usable in a simple, intuitive and quick way buy every computer-user even if not a computer-specialist.

The invention also aims at allowing the simultaneous realization, based on the same equipment, of information treatment that allows elaborating and/or to layout editable characters. In specific, the invention aims at allowing the automated calculation of editable characters and the automated filling of zones in a printed document with precalculated characters.

For this reason the invention also aims at proposing a device and method, a procedure and a software-product that offer important possibilities of configuration and programming to allow their adaptation to the constraints or needs of each individual application or user.

The invention furthermore aims at proposing a information-technology device and method, a procedure and a software-product that are compatible with current and most wide-spread computer-equipment, including the clock-frequencies of microprocessors, their memory capacity in random access or mass-storage memory and the use of personal computers available on the market.

The invention also aims at allowing securing the characters and original marks, which are normally invariable, of printed documents by preventing their modification. The invention also aims at allowing the modification of certain characters or marks originating from a printed document if necessary.

In order to do so, the invention concerns a device and method for automated, computer-aided filling of printed documents that contain marks—explicitly those may explicitly contain frames, borders, lines, columns, patterns markers, signs, graphics, logotypes, alphanumerical characters, . . . —and in which characters have to be edited, this device containing information-technology means of numerical treatment that are adapted and programmed for:

Allowing the storage and display on electronic graphics monitors of an image called initial image, which represents the printed document to be filled,

Automated identification of subsets in the initial image that correspond to pictures,

Allowing the option to define at least one frame, called Edition-Frame, that covers a subset of the initial image in which at least one character is to be edited,

Automated identification of those subsets in each Edition-Frame of the initial image of the Initial Image that are called invariable graphical subsets, corresponding to marks that extend into the Edition-Frame but have at least one that is higher than a predetermined value.

In this preferred embodiment the invariable graphical subsets correspond to marks that have at least one dimension that is higher than a predetermined value.

In this preferred embodiment the invariable graphical subsets correspond to marks that exceed the limits of the Edition-Frame.

In further variations the invariable graphical subsets may be defined to correspond to marks that have at least one dimension exceeding a value defined in absolute manner. Pixelised images are an example where the invariable graphical subsets may contain marks with an extension (=total number of neighboring pixels, which means those next to each other or with a distance between them that is inferior to a predefined value measured in pixels or any metrical measure) that is larger than a predefined value. Similarly the invariable graphical subsets may contain marks with an extension is lower than a predefined value (it may be stains, defects, small characters printed in the initial image . . . ).

In this preferred embodiment, the means of information-technology are adapted to:

Allow the activation of means to character modification, adapted to allow the edition of at least one character, called edited character, and able to place it at a predefined point in at least one Edition-Frame of the initial image.

Automated modification of each subset of the initial image within the edition-frame that is covered by at least one edited character, with exception of invariable graphical subsets, which remain unchanged, thereby creating an image called filled image of the printed document.

Note that for a device and method corresponding to the invention the initial image is entirely and automatically analyzed during the step in which the different marks are identified, before the creation of any Edition-Frame or the edition of characters in any way. The inventor in fact found out that even if this step of analysis may be intense and unnecessary it allows obtaining compensating advantages, regarding the immediate treatment of any Edition-Frame, and the identification of invariable graphical subsets within an Edition-Frame.

In this preferred embodyment the means of information technology are adapted for automated identification of marks as subset of the initial image having a different color than a predefined color, called background color.

This background color may be automatically defined as the color with the most pixels of that color in the initial image, or by a threshold (at least one component of the code corresponding to the color is lower or higher then a predefined threshold-value); or it may be defined by user-input. This background color corresponds to the original color of the base-material on which the document has been printed. (Usually the paper).

The initial image may have been pre-memorized in a computer memory in appropriate manner, for example by simple scanning of the printed document with the aid of an optical image scanner. Another variant is the creation of this initial image with the aid of software-tools that are implemented on a computer or to read files representing this initial image from storage media on which that file is stored, or even the use of such a file that has been obtained via local-area-network or internet.

The invention starts from the simple observation that within a frame which partially covers a zone of a printed document (not the total initial image), the within that frame which exceed a predefined threshold in at least one dimension—especially those exceeding the frame—and form an invariable graphical subset must not be modified and represent zones or fields within the printed document that are to be filled. Those zones must not be modified; they even impose the dimensions of the corresponding edited characters, but also can be used to calculate those dimensions.

Note that some programs or devices of text or image processing incorporate the possibility of superposing two images on the screen. One of these images is the background image, which may correspond to the marks, where the other image may be only containing changes made to the background image.

Furthermore this possibility does not allow identifying the invariable graphical subsets in the edition-frame and therefore does not allow differentiating between different elements of the image (characters, stains, background . . . ) This possibility does not allow to handle the invariable graphical subsets appropriately and to independently treat the edited characters and/or other elements of the background image. Therefore this possibility does not allow determining automatically the initial characters that already exist in the background image in order to replace them by edited characters without risking modifying invariable graphical subsets.

In this preferred embodiment a computer is adapted to automatically identify each of those subsets of the initial image that are called initial characters in each of the edition-frames, which corresponds to a mark extending entirely throughout the edition-frame that is not identified as invariable graphical subset.

In another variation of the invention it may be needed to erase the invariable graphical subsets in order to conserve the initial characters, for example in order to perform character recognition only on the initial characters. Therefore In this preferred embodyment a computer is adapted and programmed to automatically modify each of the original images subsets in the edition-frame by eliminating the invariable graphical subsets while conserving initial characters.

In this preferred embodyment a computer is adapted to erase at least one of the initial characters within an edition-frame that is at least partially covered by an edited character.

Additionally the device and method of the invention is also comprising the steps of a computer which incorporate a program for character recognition able to attribute an identification code—for example an ASCII code—that has been memorized according to one known form of a family of predefined known object-forms to each initial character. The computer is adapted and programmed to execute such a recognition program to identify at least the initial characters in at least one edition-frame. The identified initial characters may then be processed by other data processing programs in order to replace them by the edited characters and/or to modify them and/or to erase a subset or to reintroduce them into the image in order to form the filled image.

In this preferred embodiment the computer is configured with at least one program able to treat numerical data that has been selected within a spreadsheet or a text-editor and an image-processing program that is configured with the settings that are predefined by the image that is to be filled, tools that allow the user to connect each edition-frame with such a numerical-data-processing programs output or input interfaces. The computer is also adapted to define data that is generated by the pre-mentioned program as edited characters.

In the case of printed documents constituted from calls to tender it is most often necessary to edit the quantities and prices/unit arid Lo calculate the price/article a sum which may or may not be duty-free, the taxes that have to be added, the price with all taxes corresponding to the specific market included, and values to add to other precalculated values (for other types of printed documents) and to keep them in memory. Edition-frames may be defined for the zones that correspond to that data and are associated to pre-configured files of a spreadsheet program that treats the initial characters like data of that file, modified and/or completed and/or erased, and then reintroduced into the image as edited characters in order to create the filled image.

A computer may automatically do the reintroduction of the edited characters following a modified spreadsheet file.

Different known types of image-storage may be used.

In this preferred embodiment, the device and method is comprising the steps of the initial image being a numeric pixelised image and the computer being configured with means of analysis for the initial image that are adapted to automatically create a dynamic list of marks of the initial image, each mark of that list being formed by a single set of adjacent pixels, represented by their coordinates and having a color-code that satisfies at least one predetermined condition.

Within this entire text the expression “adjacent pixels” specifies any set of pixels with a distance lower or equal to a predetermined value. That predetermined value may be defined by a distance in any appropriate units (millimeters, number pixels . . . ). In the most simple case, that predefined value is equal to 1 pixel, the adjacent pixels being those directly neighboring others.

Such a computer may be configured and programmed to realize means of image analysis which regroup the adjacent pixels in a similar way (color-code satisfying at least one predetermined condition) while separating and identifying the invariable graphical subsets in the initial image of the printed document. For example each rectangle, every line and every initial character present on the printed document is identified. In the invention, the step that consists of generating such a list allows to automatically identify the marks of the initial image, and constitutes therefore the corresponds to the step realized so far.

In this preferred embodiment the device and method is also comprising the steps of means of analysis of the initial image, including mean of sorting and/or filtering adapted to automatically generate an image with colors that are part of a palette that contains a predetermined number—usually 2—of colors from the initial image, where one color corresponds to the background color of the image and each mark in the list being a set of adjacent pixels having a different color-code than the background color.

In this preferred embodiment each mark in the list builds a set of adjacent pixels having the same color-code. Reciprocally each set of adjacent pixels that have the same color-code (or in variation, similar color-codes) build a single invariable identifiable mark of a corresponding entry in the pre-mentioned list.

In this preferred embodiment the computer may be configured to automatically compare the coordinates of the pixels in each mark of the list with those of pixels within an edition-frame, in order to automatically determine if one of them is part of that edition-frame, and, if that is the case, to automatically determine if pixels of that same market exist that have coordinated exceeding predefined limits—usually those outside the edition-frame—, in way that identifies those marks as invariable graphical subsets. Similarly, In this preferred embodiment, a computer is configured to automatically compare the coordinates of pixels of each mark in the list with those of pixels of a edition-frame, in order to automatically determine if one of them is part of that edition-frame, and, if that is the case, in order to automatically determine if each of those pixels of that same mark have their coordinates within predetermined limits—usually inside the edition-frame—, in a way that identifies that mark as an initial character.

In this preferred embodiment a computer is configured to automatically examine each mark of the list after another, and,

If it is identified as invariable graphical subset, not applying a character recognition program to that mark,

If it is identified as initial character, automatically applying

A character recognition program to that mark.

In order to do so, it is possible to create a temporary image, which only contains the initial characters, the invariable graphical subsets being erased.

Therefore it is possible to either let the initial character unchanged, in order to conserve its authentic form, or to erase the mark of the edition-frame corresponding to the initial character by applying the background color to each of its pixels. Furthermore the pixels, which correspond to each initial character, are still memorized and known in the list. In a way that, in the case where an initial character has been erased and then not been modified and has to be reintroduce in the filled image, two possibilities exist: either one reintroduces the character in its recognized and edited, by the means of character edition, form or one reintroduces the pixels memorized in the corresponding list to the image. In the second case, In this preferred embodiment, the computer is configured to conserve or automatically incorporate the pixels of the mark in the list corresponding to the invariable graphical subsets and to the edited characters. Each unchanged initial character, even if recognized, appears in the exact same form that he had in the initial image, without modification of typeface or size. In the first case, on the contrary, a modification in form will generally appear.

In this preferred embodiment the computer is configured to automatically calculate the dimension of each edited character in a way that is compatible with the invariable graphical subsets and with the edition-frame, and that the edited character is placed in the right way in the filled image.

The edited characters may be edited manually by a user, or being the result of data processing program, or more generally being obtained by a computerized automatic treatment or via a data-transmission network. They are furthermore being processed by character editing means, a text-editor program for example, which are configured to adapt the size of the characters to the size of the edition-frame that contains the pre-mentioned point at which the edited characters are to be placed. The placement of each edited character may be calculated by a computer-program starting from the initial characters and/or the invariable graphical subsets, if they exist. The dimensions and placement of the edited characters may also be defined by the user that is enabled to set a number of cells which surround the edited characters horizontally and/or vertically, within each edition-frame.

In this preferred embodiment a computer is configured and programmed to activate means of character-edition, commanded by a program that enables the user to move a pointer and a predetermined point of edition at which the edited character is to be placed in the initial image. A variation is that this predetermined point may be automatically calculated by a computer, based on the dimensions of the edition-frame, and those of the corresponding edited characters, in order to center and/or adjust the edited characters appropriately in a way similar to a text-editor or spreadsheet.

In this preferred embodiment a computer is configured and programmed to allow the definition of each edition-frame by the use of a pointer-program or graphical user-interface.

In this preferred embodiment a computer is configured and programmed to allow the reintroduction of the filled image in a stable form, usually printed, or memorized on storage-media, or transmitted via local-area-network or internet in encrypted or unencrypted way. In the most common variation the “filled” printed image obtained may then be used like a printed document that has been manually filled. But the invention opens an increase on perspectives more important to the transmission and usage of printed documents via local-area-networks or the Internet.

The invention extends a method implemented in a device and method of to the invention. The invention concerns therefore a computer-device, build of a computerized means of numerical treatment and at least one electric screen for display, a method of automated filling of printed documents containing marks by computers—usually containing frames, borders, lines, columns, patters, markers, signs, graphics, characters or alphanumerical signs, . . . —and in which the characters have to be edited, this method containing the steps:

Displaying an image, called initial image, that represents a printed document on an electronic screen,

Automatically identifying the subsets of the initial image that correspond to marks,

Defining, within that initial image, at least one frame, called edition-frame, that covers a partial zone of the printed document in which at least one character has to be edited,

Automatically identifying, within each edition-frame, each subset of the initial image, called invariable graphical subsets, which correspond to marks that extend within the edition-frame but have at least one dimension exceeding a first predetermined limit and/or being inferior to a second predetermined limit.

Exceedingly those steps also characterize a method of the invention:

Activation of character-edition means that are adapted to allow the edition of at least one character, called edited character, and able to place it at a predetermined point of at least one edition-frame of the initial image,

Automated modification of each subset of the initial image within the edition-frame that is covered at least by one edited character, with the exception of invariable graphical subsets which remain unchanged, and thereby the generation of an image, called filled image, of the printed document.

The invention contains a software product that can be loaded into the random access memory of a computer for the creation of a method of the invention, in order to realize a device and method of the invention.

That software product is a computer-program that can be provides via computer-networks, and that is adapted to be 1u directly charged into the 1random access memory of a computer. It may also be provided in storage-media. The invention contains therefore also storage-media that is adapted to be connected to a computer that is comprising the steps of understanding a stored program that is adapted to be loaded in random access memory of a computer and program it to provide a method of to the invention, in a way that a device and method of to the invention is realized. A storage-media of the invention contains therefore a software-product that follows the invention and allows, when it is on the drives of a computer, that the software-product after being loaded into the random access memory of the computer provides the possibility of filling printed documents with a computer.

The invention also consists of a device, a method, a software-product and a storage-media, which are comprising therefore in the list, and all background pixels, which occur more often usually, are not memorized, which considerably reduces the memory usage of the list. Therefore a file of reduced size is obtained that still incorporated all relevant information of the image.

This is only possible if a background can be effectively defined, like it is the case for printed text or lists (the background being formed by pixels with a color of the original material on which the printed document has been realized). In contrary that is not possible if the printed document contains relevant information on its entire surface, which is for example the case in a photograph.

Other goals, characteristics and advantages of the invention appear during the lecture of the following description, which refers to the figures appended:

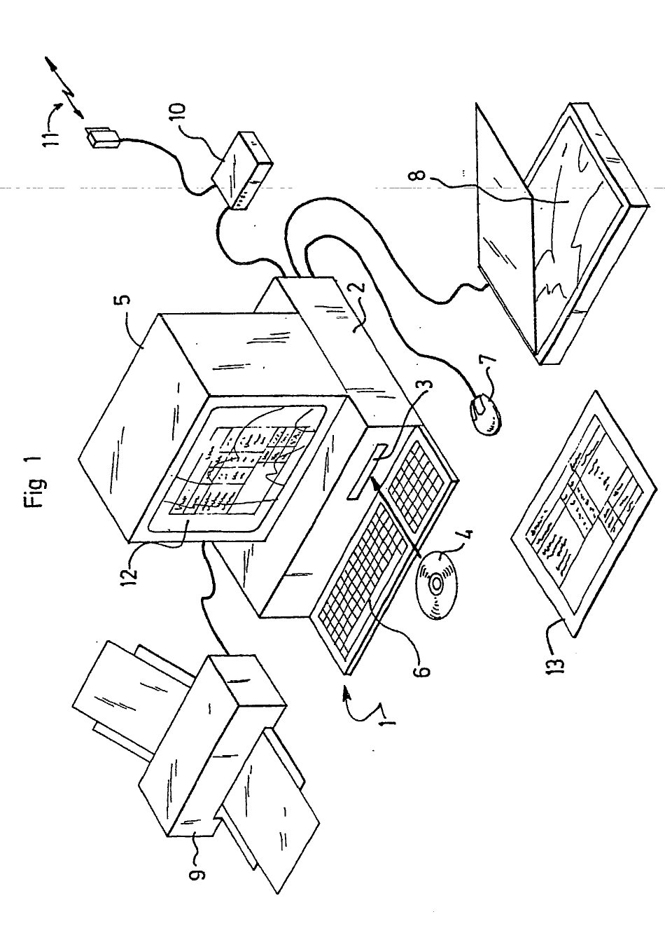

FIG. 1 is a schema illustrating an example of a device and method of the invention,

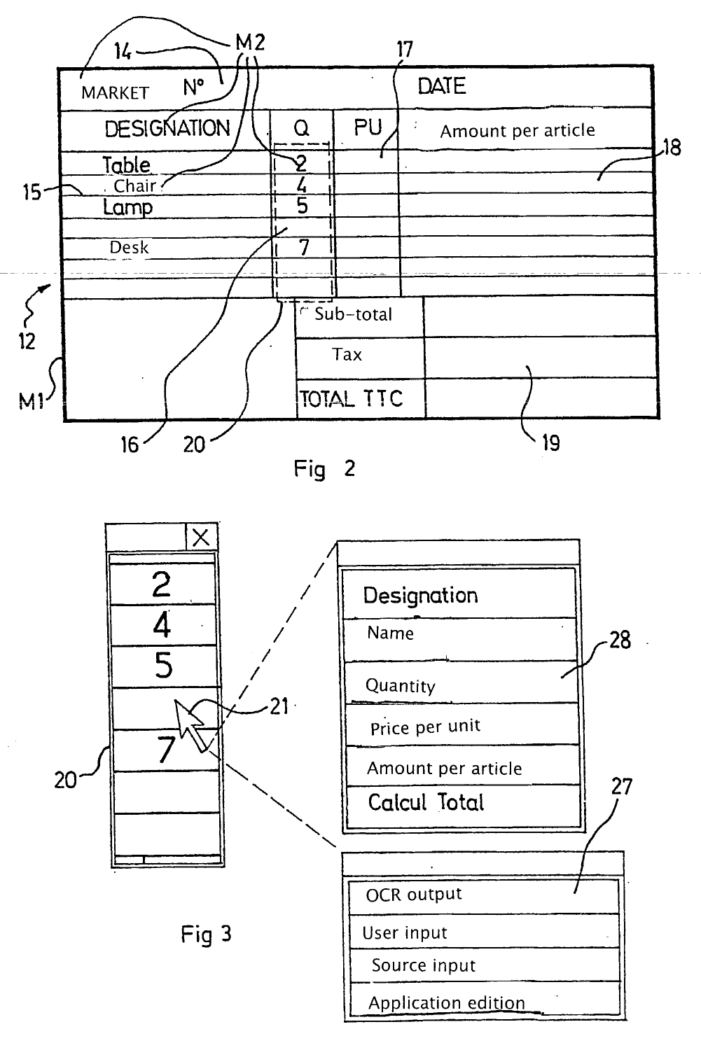

FIG. 2 is a schema that shows an example of an initial image of a printed document that is to be filled with a device and method, method and software product of the invention,

FIG. 3 is a schema that shows an example of an edition-frame being opened with a device, method and software-product of the invention,

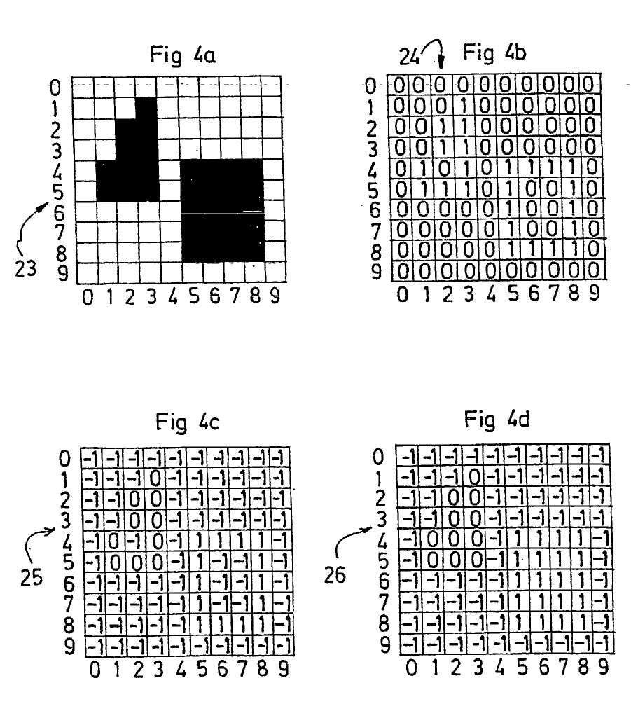

FIGS. 4a to 4d are schemas representing an the steps of combination by all or some of the characteristics mentioned above or below.

Furthermore, the invention concerns a more general way of a method to numerically process pixelised images that is comprising the steps of :

Subsets of the image are identified to correspond to marks having a color-code satisfying at least one predetermined condition

A dynamic list which contains all marks of the image, each mark of the list being formed by a single set of adjacent pixels selected by the coordinates is created.

The invention permits to recognize and isolate automatically the different marks of a numerical image, and then processing that image not by its pixels, but that dynamic list, each entry containing and regrouping the coordinates of each mark. It is therefore possible to do these analysis or recognition processes in a more simple way than possible with the preceding state of the art. In this preferred embodiment it is determined (automatically (by sorting or by considering the color most pixels have) or by user-choice) what color-code corresponds to the background color, and a list consisting only of those marks that have a different color-code that the background color.

Only the relevant information of the image is memorized example of a subset of the initial image at a zoomed scale in order to allow the distinction of the pixels, and the numeric matrixes corresponding to these subsets, different steps allowing to isolate and code the marks of these subsets of the initial image in a dynamic list, using a device, method and software-product of the invention,

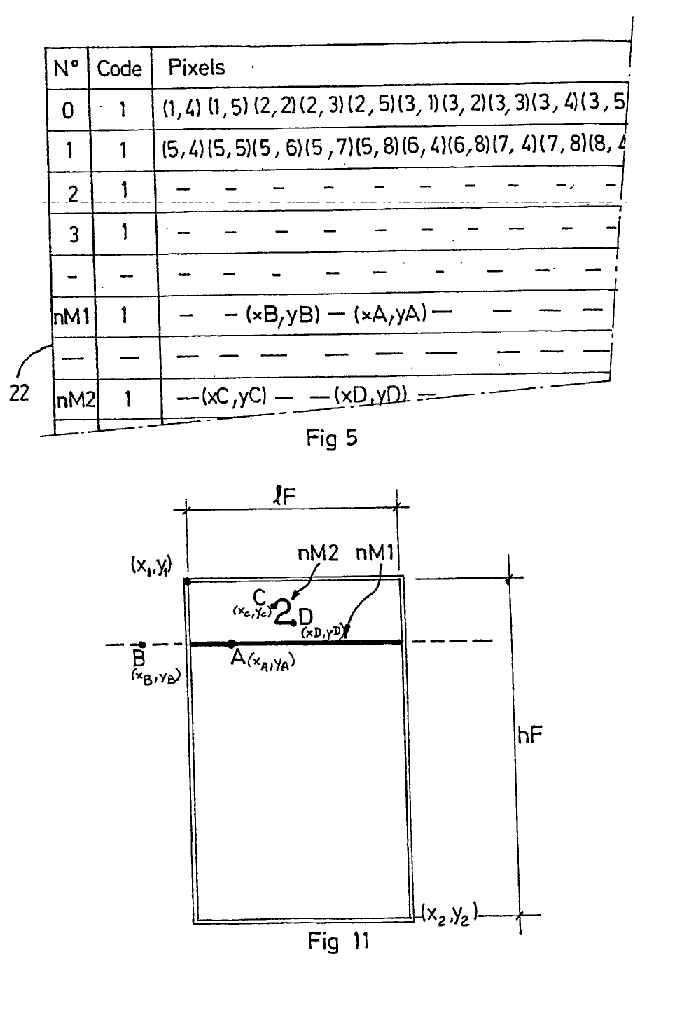

FIG. 5 is a schema illustrating an example for a dynamic list created by a device, metriod and software-product of the invention.

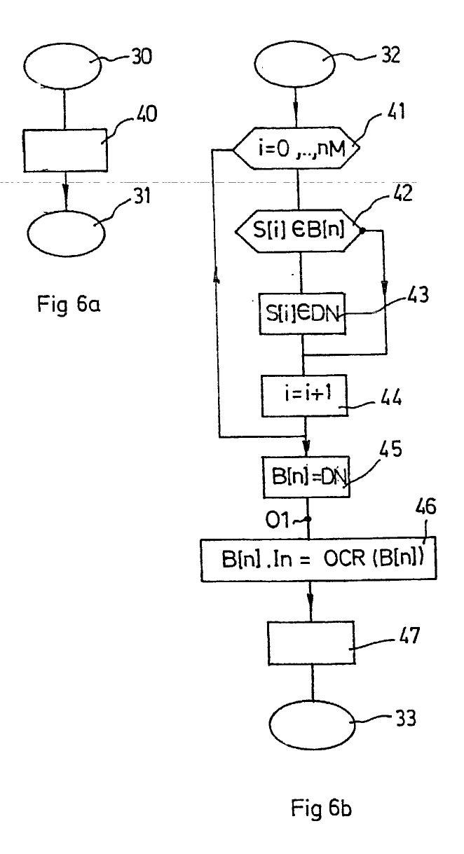

The FIGS. 6a, 6b, 7a, 7b, 8, 9a, 9b and 10 are flow-charts showing the different steps for the edition in a methods, a device and method and software product of the invention.

FIG. 11 is a schema illustrating a subset of an edition-frame in which it is possible to identify an invariable graphical subset and an initial character using a method, device and software product according to the invention.

The FIGS. 12a to 12f are schemas illustrating the different steps needed to the processing of initial characters, and the incorporation of edited characters in the edition-frame from FIG. 3,

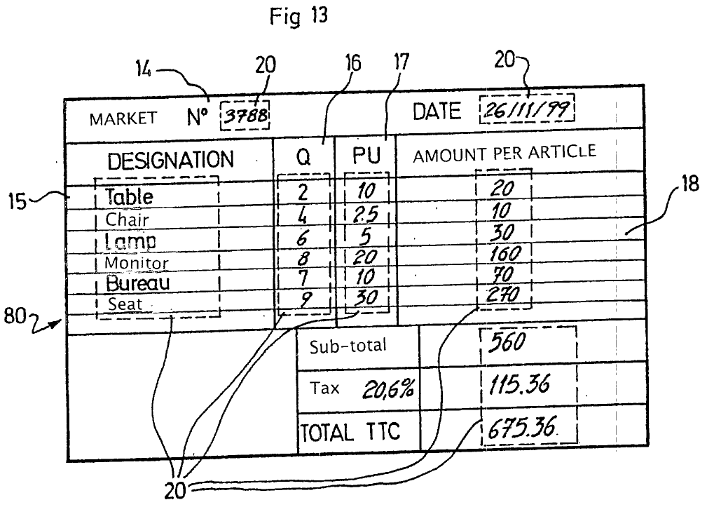

FIG. 13 is a schema showing an example of a filled image obtained by the invention and from the initial image of a printed document from FIG. 2,

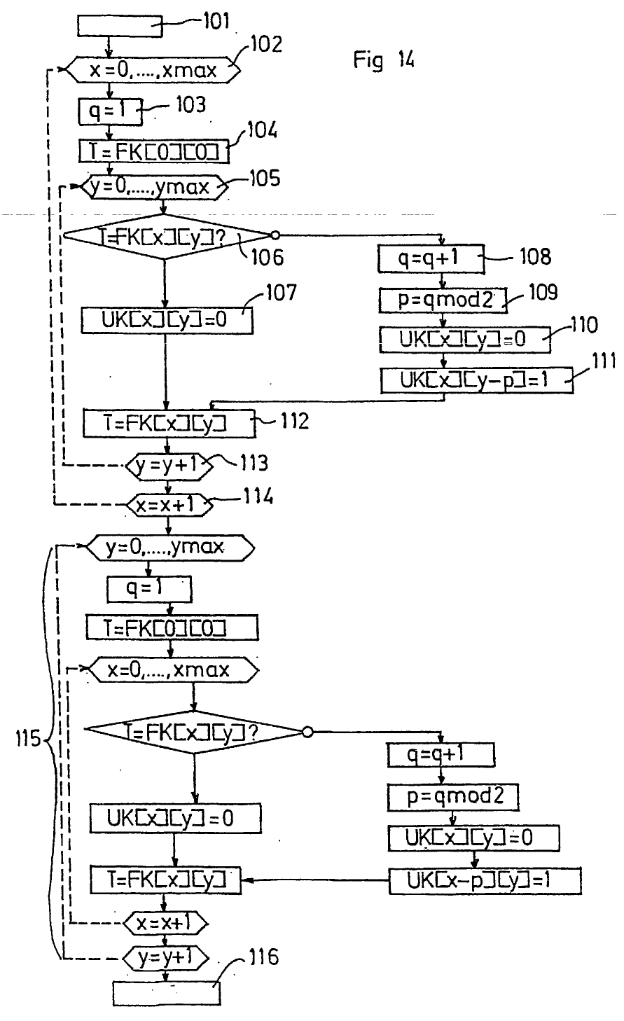

FIG. 14 is a flow-chart that illustrates a method of the invention allowing to obtain a map of the contours from FIG. 4b starting from the filtered image 4a,

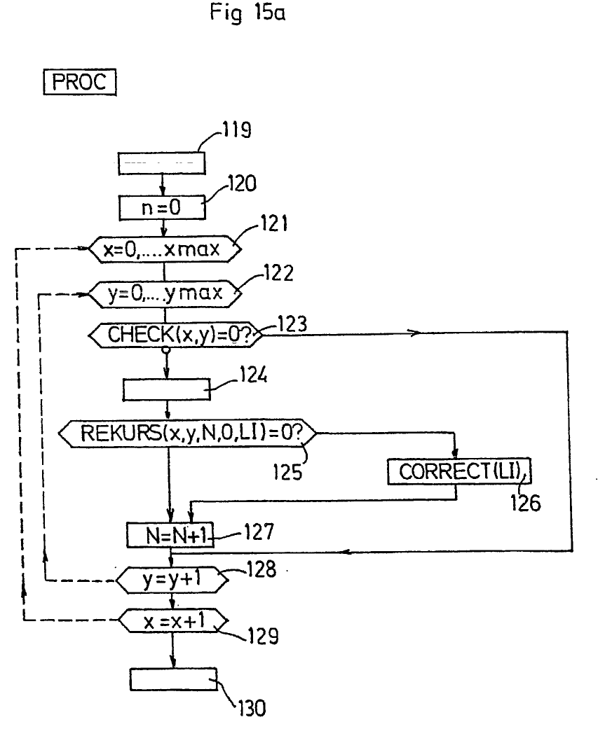

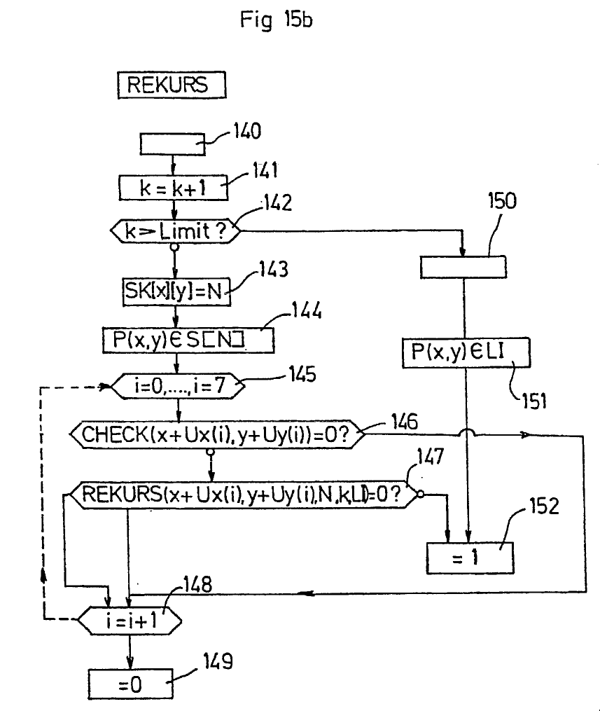

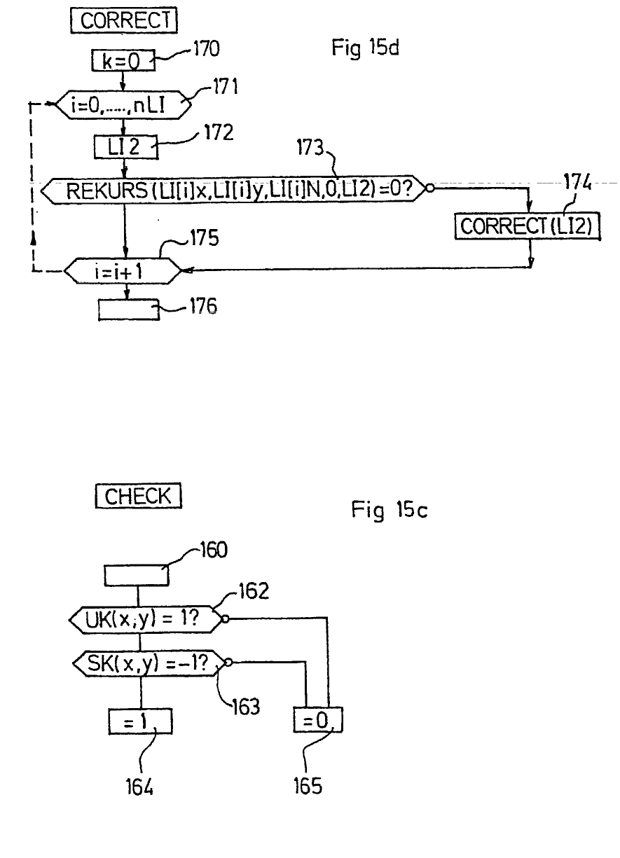

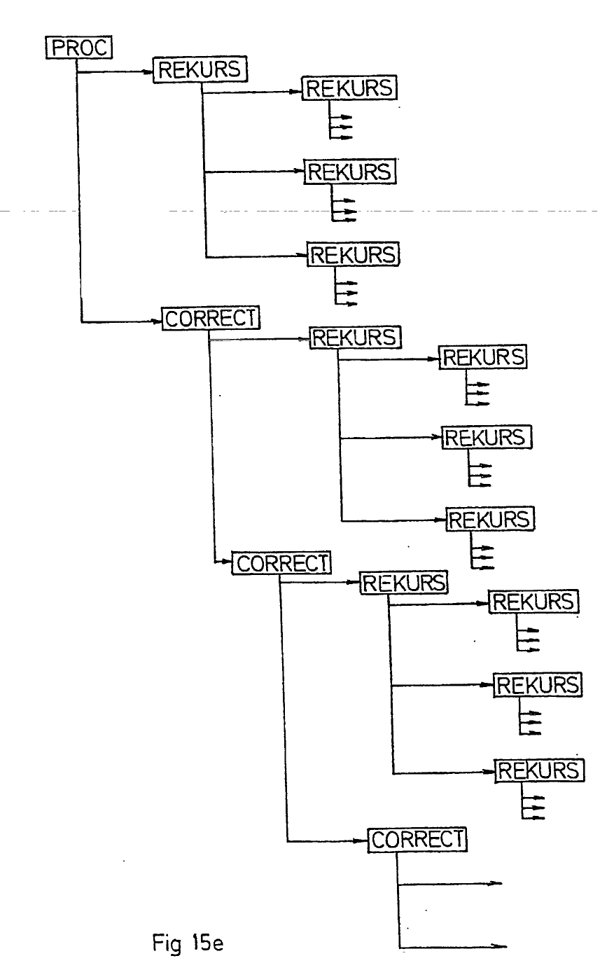

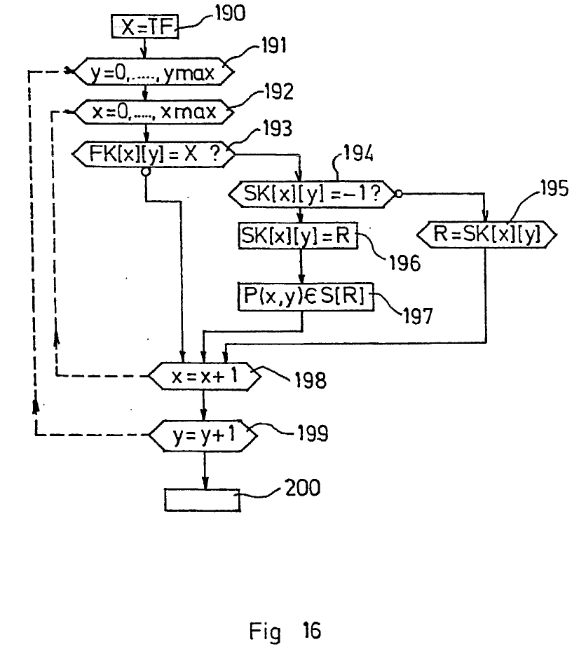

The FIGS. 15a, 15b, 15c, 15d and 15e are flowcharts illustrating a method of the invention that allows to obtain a separation-map from FIG. 4c starting with the contour image of FIG. 4b

FIG. 16 is a flow-chart that illustrated a method of the invention that allows to obtain a map of marks according to FIG. 4d starting from a separation map showing in FIG. 4b

The FIG. 1 represents an example of a device and method of the invention that contains a micro-computer 1 with a central processing unit 2 with microprocessor(s), a reader 3 of storage-media 4 like disks—usually CD-ROM—, a screen 5, a keyboard 6, a mouse 7 or any other pointing device, an optical scanner 8, a printer 9, a modem 10 with network 11 connection that allows data transmission similar to the network enabling dial-in access to the INTERNET network. Note that the device 1 represented in FIG. 1 is only an example and numerous other configurations are possible (portable micro-computer, other storage-media or other peripheral devices associated, replacement of the mouse 7 by a touch-screen, ball-based pointing devices,).

The micro-computer 1 is also configured with standard software allowing its usage, particularly an operating system that incorporates a graphical user interface, usually WINDOWS (R) commercialized by MICROSOFT CORPORATION (U.S.A.), or Max OS (r) commercialized by Apple Computer (U.S.A.), or BeOs (R) commercialized by Be (France), or X-WINDOWS (R) commercialized by SUN MICROSYSTEMS (U.S.A.)—, and a pointer-software—usually a mouse-driver contained in the operating system—.

The central processing unit 2 incorporated a microprocessor and its associated components, usually at least one read only memory and one internal random access memory. The central processing unit 2 also has at least one motherboard and at least one bus that allow the connection of different peripheral cards, also a mass-storage memory, usually a hard disk.

The microcomputer 1 is adapted and programmed to allow the memorization of a numerical image in its mass-storage memory, called initial image 12, representing a printed document 13 that has to be filled. In the example of FIG. 1, the scanner 8 that creates a numerical file representing that printed document 13, which means the initial image 12, in a traditional manner, may read the printed document 13. Such a scanner 8 is known by it and does allow creating pixelised images that are then memorized on the hard disk of a microcomputer 1. In variation, the initial image 12 may also be transmitted by network 11 or modem 10 and memorize on the hard disk of the microcomputer 1. Also, the initial image 12 may be stored on a storage-media and retrieved by a drive like the drive 3 of the microcomputer 1. The device and method of the invention is adapted and programmed to allow the display on a screen 5 of the initial image 12 like represented in FIG. 1.

More generally, in order to realize the invention, a software product of the invention and stored on storage-media 4 of the invention is inserted to the drive 3 and installed on the microcomputer 1. The files of the programs and data corresponding are copied to the hard disk, and the system files are modified to support storage 4 if necessary.

The operating system WINDOWS (R) is compatible to pre-programmed class-libraries that are commercialized by MICROSOFT CORPORATION (U.S.A.) and the name Microsoft Foundation Classes (R), which allow realizing a software product of the invention. Other libraries with similar functionality and/or targeting other operating systems may be used (UNIX, MACINTOSH (R) . . . ) in similar manner.

Starting with the activation of the program of the invention and after loading an initial image 12 with this software product (program), a program for digital image editing is started to allow the display of the initial image 12. This digital image-editing program may consist of any compatible program with the operating system of the microcomputer 1, and for example with the Win32 (R) API de MICROSOFT CORPORATION (U.S.A.).

In FIG. 2 an example on an initial image 12 of a printed document is represented, which in this example is similar to a call to tender.

The initial image 12 represented in FIG. 2 is that of a printed document as provided by an administration before being filled by the applicants to the call to tender. Obviously, in FIG. 2, a very simplified version of such a document is represented, with single goal of illustration to this invention.

Visibly, the initial image 12 of the printed document contains pre-printed marks that allow defining the zones 14, 15, 16, 17, 18, 19 that the applicant has to fill with characters of to the offer he wants to formulate.

More generally, and in the represented example, the initial image 12 is a pixelised image, a “bitmap”, in black and white. The invention, which is furthermore applicable to other image, formats, especially also vectorized images and/or color images, which have various levels of a variety of colors.

The initial pre-printed marks in the initial image 12 contain in this example:

A set M1 of black adjacent pixels that form the borderlines of a spreadsheet,

Some alphanumerical characters, called initial characters M2, each initial character M2 being formed by a set of black adjacent pixels.

In this example, the printed document contains a heading 14 that allows the edition of a market and date, a column 15 of product-designations corresponding to the market, a column 16 in which the quantities of the products are indicated individually, a column 18 that allows to edit the price for each product, and a column 19 that allows the calculation of intermediate sums, taxes, totals, etc.

Like indicated previously, the initial image 12 is displayed on a screen with the aid of a library similar to the Win32 (R) API library or the Microsoft MFC (R) class library for the WINDOWS operating system.

The program of the invention is configured to generate a dynamic list 22 representing the initial marks of the initial image 12, each mark of this list 22 being formed of a set of adjacent pixels identified by their coordinates, and having a color-code that satisfies at least one predetermined condition.

The FIGS. 4a, 4b, 4c, 4d and 5 illustrate the method that can be realized to generate such a dynamic list 22. In the entire text, the expression “dynamic” list specifies, in traditional manner, a list with variable dimensions, may vary from one initial image 12 to another.

The images are stored in the microcomputer 1 in the form of matrixes of numerical data, called maps, containing the information of each pixel. Each number of the map represents one pixel of the image, which is identified by its coordinates (x, y) in the corresponding map. The coordinates of a pixel are unsigned integral numbers. By convention, the origin of the coordinates (0, 0) is the pixel located in the left-top corner of the image.

First, a process of sorting and filtering is applied to the initial image 12, known by itself, adapted to generate an image with the colors that are part of a group of predetermined number of colors, including one color of the images background (defined by the user or calculated as being the color that most pixels of the image have, or a predetermined color whose color-code is used as minimum and/or maximum). In the represented example, the process of sorting and filtering delivers a contrasted bitonal image. FIG. 4a is at larger scale a subset of an image obtained from the initial image 12 after the process of sorting and filtering. This image is called filtered image 23. An example for such processing can be the methods based on the algorithms of HECKBERT.

Let K be a in some way determined map. Internal pixels of K are all pixels of the map K that are neither part of the last or fist columns and neither part of the first or last line of that map K. Corner Pixels of K are those pixels that are either part of the first column or last column and of the last or first line of K. Border pixels are those pixels that are neither corner nor internal pixels. 1o The neighborhood U (P; K) is the set of pixels P of a map K that are different to the pixel P but are touching it directly. The neighborhood of an internal pixel has eight pixels. The neighborhood of a border pixel contains five pixels. The neighborhood of a corner pixel contains three pixels. Starting from the filtered image 23, the map, called contour map 24, represented in FIG. 4b is constructed. Initially all elements of the map are fixed to zero. The filtered image is processed pixel-by-pixel and line-by-line, in each line pixel by pixel. For each pixel the color-code (black or white in the example of FIG. 4a) of the pixel is compared to the code examined previously. If the code of the current pixel is not the same as the one of the preceding pixel, the current pixel is a pixel where the color of the image changes, and therefore called changing pixel. There are two cases:

1) Transition for the exterior of a mark to its interior has occurred; in that case, the current pixel is a pixel called contour pixel, that build the peripheral contour of a mark in the initial image 12; its value is therefore set to 1 into the contour map 24;

2) Transition from the interior of a mark to its exterior has occurred; in that case the current pixel is immediately preceding a counter pixel and its value in the contour map is 24 set to 1.

To differentiate between those two cases, the number q of changing pixels in the current line is counted during the examination of pixels. The initial value for q is fixed to 1 so that every new line q will have the value 2 for the first changing pixel of the line. Therefore it is known that if q is an even number during the detection of a changing pixel, it is the case 1) elsewise, if q is odd it is case 2).

While successively examining all the pixels of the filtered image 23, the contour map 24 in which the contour of any mark is represented by the value 1 is created.

FIG. 14 is an exemplary flow-chart allowing the realization of the above-described method to obtain a contour map 24 from a filtered image 23. In this figure, after step 101 from start, one will encounter a loop in step 102 that allows the processing of the abscises x, from 0 to xmax, which means the pixels of the filtered image 23 line by line.

The variable q is initialized with 1 after step 103. In step 104 the value of the color code T of element FK[0] [0] that is the code of the color from the point at the coordinates (0, 0) in the filtered image 23.

In the flow-charts of FIG. 14, 15a to 15e and 16 the following terminology is adopted:

FK[x] [y]: the color code of the pixel from the coordinates (x, y) of the filtered image 23

UK[x] [y] : the color code of the pixel from the coordinates (x, y) in the contour image 24,

SK[x] [y] : the color code of the pixel from the coordinates (x, y) in the separation image 25 or mark map 26,

S[N]: symbol with the number N in the dynamic list 22

P(x, y): pixel from the coordinates (x, y).

After step 105, a loop is entered that processes the ordinates y of the pixels in the filtered image 23, from 0 to ymax.

In Step 106, it can be examined that the variable T is equal to the color code of the pixel at the current coordinates (x, y), being FK[x] [y]. If such is the case the code of the contour map 24 is fixed to 0 for that pixel entered, and step 112 where a loop over the ordinates y of the contour map 24 is entered.

Therefore step 123 which invokes the function CHECK represented in the flow-chart of FIG. 15c is executed for each pixel. After a initial step 160, we proceed with step 162 if the code of the contour map 24 of the current pixel at coordinates (x, y) equals 1. If this is the case CHECK always returns 0 in step 165, i.e. CHECK(x, y)=0. In that case, after step 163, if the code in the separation maps 25 of the pixel with coordinates (x, y) equals 1. If it is not the case, in step 165 CHECK returns 0. If it is the case CHECK returns 1 in step 164. Therefore if the function CHECK is equal to 0, it is known that the pixel has been processed or is not a contour pixel. If CHECK returns 1 though, it is known that it is a pixel that hasn't been processed by PROC and that is a contour pixel. Therefore step 123 from FIG. 15a, if CHECK evaluates to 0, one continues directly with 128, the end of the loop over the ordinates y. whereas when CHECK evaluates to a value that is not 0, a new entry is added to the dynamic list in step 124, in a way that allows inserting a new mark. To achieve this value N is attributed to the new mark, called code of mark N, which is an unsigned integral number that allows indexing the marks in the dynamic list 22. The first value for N equals 0. A dynamic list according to FIG. 5 is created, the first column during step 107. If such is not the case, q is incremented by one during step 108, and it is possible to calculate the value p which is equal to 0 if q is even and equal to 1 if q is odd, during step 109. In the subsequent step, the code of the pixel at coordinates (x, y) is set to 1. The Steps 107 and 111 lead both to step 112 in which T is modified by giving it the color code of the pixel at coordinates (x, y) in filtered image 23 as value. During steps 113 and 114, the loops are terminated and y, respectively x are increased by 1. When the entire filtered image 23 has been processed the steps 115 in FIG. 14 which are similar to the preceding ones but in which the ordinates y are the first being opened. Further the step 111 is replaced by a step in which the code of the pixel at coordinates (x-p, y) is fixed to 1 after the execution of this step 115 is taken, which lead to the final step 116.

Starting from the contour map 24, another map, called separation map 25 is created, which is represented in FIG. 4c where the different marks are seperated from each other. To achieve this every pixel of the separation map 25 is initialized to −1. Then the subprocedure PROC which is represented in FIG. 15a is invoked.

This subprocedure starts with step 110. Then in step 120 in which the variable n is initialized to 0, step 121 where a loop over the abscisses x of the contour map 24 is representing the code of mark N and the second column representing the color code that corresponds, and which each line contains the different pixels identified to be part of that mark.

Now the function REKURS is invoked, which corresponds to the flow-chart in FIG. 15b. It allows examining the neighborhood of the current pixel. Starting with step 140, in step 141 k is incremented by 1, which was initialized to 0, which allows to calculate the number of times that the function REKURS has been invoked. in fact the function REKURS is a function that invokes itself, therefore one called self-recurrent. It is known that the capabilities of computers to perform recurrence are limited. The procedure represented in FIG. 15b allows therefore interrupting the number of executed recurrences in order to not exceed the limits of the used computer. Those capabilities are defined by a constant called Limit. If such is not the case the code of the separation map 25 i fixed to the value of the code of mark N, introduced in step 143, and written to the current pixel P(x, y) in the dynamic list 22, which means in the mark which has the code of mark N, in step 144.

Then in step 145 a loop over the neighboring pixels of P(x, y) is entered. This loop is executed over an index i which runs from 0 to 7 and that allows varying the increments by 1 for the abscises and the ordinates Ux(i) and Uy(i) relative to the coordinates (x, y) of the current pixel. The increments Ux(i) and Uy(i) can have the values 0, 1, and −1, and the eight combinations that are not equal to (0, 0) can be formed with the three values determining the neighboring pixels of P(x, y). Each combination corresponds to one of the values of the index i, which means the point (x+Ux(i), y+Uy(i)) is one of the neighboring pixels of (x, y).

In Step 146, the function CHECK that has been described above is invoked for each neighboring pixel and its return value is examined. If it equals 0, it will be continued with step 148, the end of the loop, which means the return to the previous neighborhood. If it is not equal to 0, the function REKURS is invoked again for that neighboring point, with a code of mark N. The return value is examined in step 147. If it equals 0, that signifies that REKURS could be executed completely for every contour pixel of the mark with code of mark N, without interruption in the recurrence. If in contrary REKURS returns a non-zero value, in other words it return 1, it is known that the value of Limit has been reached and that recurrent iterations will be required. This is the reason why when detecting during REKURS that the current neighboring point with the index i is not equal to 0 in step 147, REKURS returns 1 for the current point (x, y) in step 152. If in the other case the value of REKURS for the neighboring point equals 0, step 148 is executed and the end of the loop over the neighboring points is reached, in other words i is incremented by 1.

When all neighboring points could be examined, the value of REKURS is fixed to 0 in step 149.

If during step 142, the recurrence threshold Limit is exceeded, the coordinates of the pixel (x, y) ate which the recursion had to be interrupted are added to a dynamic list called correction list LI. This is done in step 151 that is preceded by step 150 in which the length of the list LI is incremented by 1. After step 151 REKURS returns 1 in step 152, allowing detecting the interruption of recurrence.

In the global procedure PROC, if during step 125 it is detected that the function REKURS is not equal to 0, and therefore an interruption has occurred, the function CORRECT(LI) with corresponding flow-chart in FIG. 15d is invoked in step 126. This function allows to continue the function REKURS that has been described above starting from each of the nLI pixels contained in the list LI, but having reinitialized the value of recursion to 0, since recursion is restarting. The function contains step 170 in which k is reinitialized to 0, since in step 171 a loop over the index i running from 0 to nLI is entered, which allows the execution of each REKURS function. In that loop first of all a local dynamic list LI2 is reset in step 172. In step 173 the function REKURS is invoked for the current pixel, corresponding to the entry i in the list LI, with a current code of mark N, the value of k is set to 0, and instead of the interruption list LI the local list LI2 is used. In step 173 the return value of REKURS is also examined.

If it is equal to 0 the loop over i is exited while incrementing i by 1 in step 175, moving on to the next entry in LI. If it is not the case CORRECT is invoked another time in step 174, not with the original dynamic list LI but using the local list LI2. After doing so the loop is exited in step 175. After the processing of all entries the loop is terminated in step 176.

After step 126 where the function CORRECT is applied to the interruption list LI, or after the execution of the function REKURS in step 125 of the sub procedure PROC, the current code of mark N is incremented by 1 in step 27, and the loops over the ordinates y from step 128 and over the abscises x from step 129 are terminated. This way all points of the contour map are processed, terminating with step 130.

FIG. 15e show schematically the function-call tree of the sub procedure PROC and the function REKURS and CORRECT. Obviously the sub procedure PROC invokes the function REKURS which invokes itself one or multiple times, with high or low recursion level k. The function CORRECT invokes the function REKURS in a similar way, and invokes itself multiple times, too.

Note that in certain applications, such a limitation to the number of recursions may be absolutely necessary. This is particularly the case when marks are made of a simple geometry, for example consisting only of lines and the computer being sufficiently strong.

In the example of FIG. 4c, the separation map 25 contains a mark with a code of mark equal to 0 (N=0), another mark with a code of mark equal to 1 (N=1). In the separation map 25 each mark is separated from other marks, since each of its contour pixels have been identified.

In the next step, each of the marks are filled in order to add the pixels placed in the interior of the mark to the dynamic list 22 and in order to create a new map, called mark map 26, represented in FIG. 4d. Note that this step may in certain applications be omitted since the geometric extension of a mark in the initial image 12 is entirely determined by its contour pixels in the separation map 25, represented in FIG. 4c. This is particularly true for marks that are made of alphanumerical characters or simple lines. Whereas, in the case of marks with big surfaces, it is preferable to perform the filling step.

Note also that in contrary in the case of marks with simple geometry, it is not necessary to identify the contour pixels in order to create list 22 and to identify the individual pixels of each mark in the image. In fact it is possible to directly create the mark map 26 from the filtered image 23 as described below. Furthermore the identification of contour pixels in advance as described above allows accelerating significantly the process in the case of marks with complex geometry. Especially when combining alphanumerical characters with frames, like for example in some traditional printed documents.

In order to realize this filling step, the separation map 25 is processed again, the pixels are examined columns by columns, line by line like described above. Simultaneously the filtered image 23 is examined concerning the color of each pixel. At the first contour pixel of an encountered mark in the separation map 25, it is assumed that the color of that first encountered contour pixel from that mark in the filtered image 23 corresponds to the color of the mark. The processing of the separation map 25 continues. At the next pixel the value in the separation map 25 is necessarily either the same (N) of the preceding pixel, which is a contour pixel, or has the value −1. In this second case the color of the corresponding pixel in the filtered image is examined. If that color is the same than that of the preceding pixel, which is a contour pixel, the value in the map is altered to N, since it is a pixel in the inferior of the mark. But if the color is not the same than that of the preceding contour pixel, is must be a pixel at the exterior of the mark, and therefore processing may continue with the next pixel. By processing all pixels in the separation map 25, the interior of the marks are being filled and the mark map 26 has been obtained. At each altering of a value, the coordinates are, of course, added to the entry of the mark in the dynamic list 22.

FIG. 16 represents an example of a flow-chart allowing to realize the mark map 26 starting with the separation map 25. During the initial step 190, a variable X is set to the value TF that corresponds to the color code of the background in the filtered image 23. This color code may have been calculated in advance or set by the user as described above.

During step 191 a loop over the ordinates y from 0 to ymax of the filtered image 24 is entered, and in step 192 another loop is entered over the abscisses x, from 0 to xmax. During step 193, the color code in the initial image 23 of the current pixel (x, y) is compared to X. If this code is different from the code of the background the current pixel is not part of a mark, proceeding to step 198 and 199 where the loop is exited, the abscises and ordinate are respectively increased by 1. Else wise it is examined if the code of the separation map 25 equals −1 in step 194. If not, it is a previously identified contour pixel, therefore R is set to the value of SK[x] [y] of the pixel in the separation map 25 during step 195, continuing with steps 198 and 199. In the other case it can be found that the code in the separation map 25 equals −1. That value is changed to the value of R in step 196, since a interior pixel of a mark has been identified. During step 197 the pixel P(x, y) is added to the dynamic list 22 in the entry corresponding to the mark with code of mark R. The loop is exited in step 198 and 199. By these means the marks in the separation map 25 are filled. Once all pixels have been processed, the flow-chart ends with step 200.

The creation of the dynamic list 22 has been described referring to an initial image 12 and a filtered bitonal image 23. It is easily understandable that this process could also be applied to the case of multiple distinct colors obtained after sorting and filtering. For example, if the image contains four colors, a similar process can be realized.

Preferably, the operation of sorting and filtering allows to obtain a filtered image 23, where all joint pixels with a color code differing from the background colors code, are attributed the same color code. Hence a single mark is formed of adjacent pixels of same color.

In the dynamic list 22, the individual marks of the initial image 12 constituted of adjacent pixels, which have therefore been identified and separated from each other. This method is automatically done for any opened initial image 12, in other words, loaded to random access memory, due to the programs of the invention. This method can be associated to the function of editing the loaded image during activation of the program and of the invention during load of the initial image 12.

During startup of the program of the invention and during opening of the initial image (during its load into random access memory), not only the image-editing function is activated, but also the (mouse-) pointer-program is launched and associated to a program that allows to define one or more edition-frames 20, superposing the original image 12, as represented in dotted lines in FIG. 2, and more detailed FIG. 3. The user may do the definition of that edition-frame 20 with the aid of a pointer 21, or by a maneuver with the mouse 7 of the type drag-and-drop. From the upper left corner of the edition-frame 20 its lower right corner. Such a function for the definition of edition-frames with pointer-aid is well known to graphical user interfaces and image-processing programs. The function of defining such a frame is associated with the primary button of the pointer, usually the left mouse button 7.

During the startup of the program of the invention, a primary window is opened, containing in a traditional manner a menu-bar, and a tool-bar in order to incorporate some icons that allow to launch different programs of the application that correspond to the different functions to be realized.

While the user has defined the edition-frame, he may define the nature of the content of that edition-frame by acting on the secondary button of the mouse 7—usually the right button—which should open a configuration menu as shown in FIG. 3. In that figure, two different types are shown. In the more general example, the configuration menu 27 enables the user to define the edition-frame 20 and is aimed at realizing operations chosen according to the OCR editing; user-editing; source-editing and application-editing. Those different operations define the nature of the processing on the editing-frame 20 aiming to the insertion of edited characters. The functional flow-charts of each of those operations is described in the FIGS. 6a and 6b for the OCR-editing; 7a and 7b for user-input; 8 for source-input ad 9a and 9b for application editing.

Each of those operations has to one part the editing-function allowing reforming the content of the edition-frame 20 (flow-charts in FIGS. 6a, 7a, 9a) ant, to another part, a editing-function allowing to incorporate the edited characters into the edition-frame 20 (flow-charts 6b, 7b, 8, and 9b).

In the following pictures and descriptions those definitions are used:

B[i]: edition-frame 20 with the number i,

B[i] [j]: mark with code j within the edition-frame number i,

S[i]: mark with code i within the dynamic list 22, called S,

T(x, y : color-code of the coordinates of a pixel (x, y).

The OCR-editing operation allows recognizing the characters in the initial image 12, due to a program for character recognition and the fact of using them at startup of a numerical data processing program.

The editing function contains in any case, a starting step 30, and an end step 31. Similarly, each input function contains the initial step 32 and the final step 33. These initial and final steps are automatically executed by the program of the invention, according to the state it is in, or due to a user-command.

In the OCR-input frame, one single step, realized within in the editing function is step 40 during which parts of the initial image 12 that correspond to the edition-frame 20 are painted. During this OCR-input function there is no modification of the image within the editing-frame 20, at this state.

Le input function corresponds to OCR-input, which consists of identifying the initial characters inside the edition-frame, and to creating a new image of this edition-frame which only incorporates only the initial characters, and to then launch a OCR-program over those initial characters, which have been isolated in advance. These steps are shown in the FIGS. 12b, with the initial characters in the edition-frame 20. In order to obtain this result, it is necessary that initial characters, which are entirely contained within the edition-frame 20, be separated from marks that extend out of the edition-frame 20. These invariable graphical subsets M1 cannot contain marks whose extensions exceed a first predetermined value and/or whose extension remain under a second predetermined value.

In order to do so, as shown in FIG. 6b, a loop is entered in step 41 over the marks running from 0 to nM of the dynamic list 22. For each mark S[i] of that list is is examined if it is entirely contained in the edition-frame 20 in step 42. If such is the case, the mark S[i] is written to a new image DN of the edition-frame B[n] in step 43. If not the case, it will be directly continued with step 44 where the loop is exited and the index i of that loop is incremented by 1. At then end of those loops a new image of the edition-frame 20 as shown in FIG. 12b is obtained, which only contains the characters entirely contained within the edition-frame 20.

In order to implement step 42, for each mark its set of pixels as represented FIG. 11 is examined. If all pixels of S[i] have coordinates (x, y) that satisfy the condition x1<x<x2 and y1<y<y2, (x1, y1) being the coordinates of the pixel in the upper left corner of the edition-frame 20, and (x2, y2) being the coordinates of the pixel in the lower right corner of the edition-frame 20, it can be concluded that the mark S[i] is an initial character like the character nM2 shown in FIG. 11. It is stringent that every pixel C and D of that mark nM2 is contained in the interior of the edition-frame 20. Whereas, if a mark nM1 represents a pixel A with coordinates (xA, yA) is within the edition-frame 20, but also a pixel (xB, yB) which is outside the edition-frame 20, this mark nM1 forms an invariable graphical subset M1 and is not considered.

When executing step 42, a loop over all pixels of each mark S[i], it is examined whether its coordinates are contained within the edition-frame 20 like indicated above. For each pixel with coordinates inside the edition-frame 20, a first counter, with an initial value of 0 can be set to 1. If subsequently within the same mark a pixel outside of the edition-frame 20 is found, a second counter, with initial value 0, is set to 1. For the mark being considered as initial character, the value of the first counter needs to be 1, whereas the second counter needs to be 0. For the other cases, the mark S[i] is skipped, because it is not an initial character.

During the next step 45, a frame (memorized but not displayed) similar to the edition-frame 20, but only created from new images DN, which have been obtained before. Step 46, the recognition program, is applied to the image by invoking the input function represented by B[i].ln on that new frame, which in the case of OCR-input, corresponds to a function OCR(B[n]) for character recognition.

Any program that is able Lo recognize characters on a pixelised subset of an image as shown in FIG. 12b can be used as character recognition program. Many character recognition programs are known and may be used.

This character recognition program, in the example of FIG. 12b, allows recognizing the alphanumerical ASCII characters individually as shown in FIG. 12c. The thereby obtained values can be used directed as input for a digital data processing program, a spreadsheet or text-editor for example, as shown in step 47 of FIG. 6b.

The operation of user input/edition allows to manually edit the data by an user, with the aid of a keyboard for example, providing the option to use data from a digital data processing program like a text-editor or a spreadsheet . . . or to introduce them directly in the edition-frame at a predetermined and chosen place.

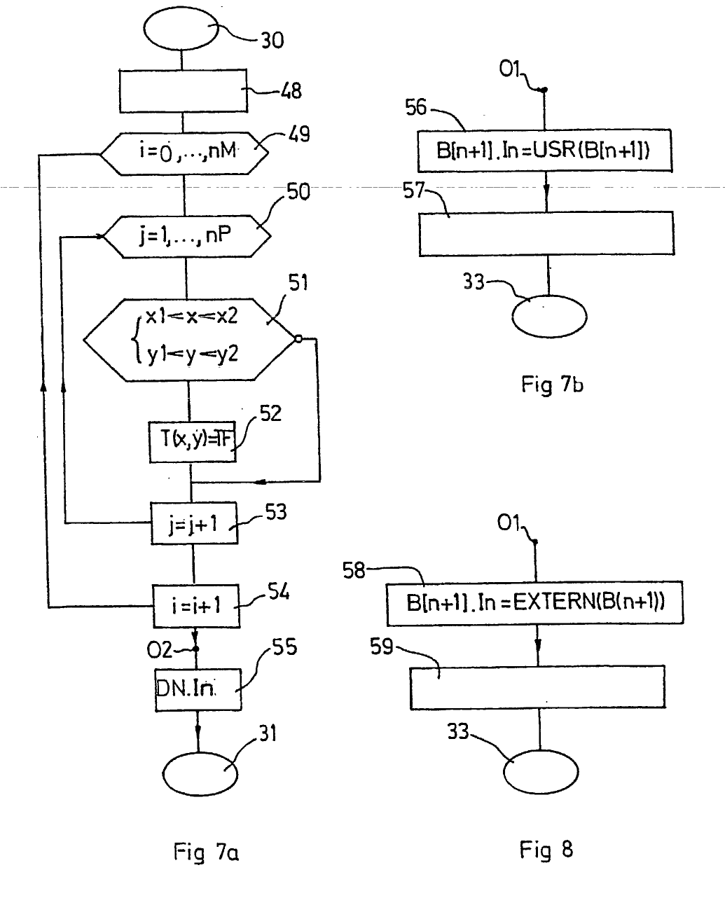

In the context of this operation, the edition function has to determine in advance which the initial characters in the edition-frame are, and erase all those initial character in order to avoid all possible and unwanted overlaying of edited characters and initial characters. This is shown in the flow-chart of FIG. 7a. After the initial step 30, step 48 draws the edition frame 20, and then in step 49, a loop over the marks in the dynamic list 22, running from 0 to nM is entered.

During the subsequent step 50, a loop designed to examine the different pixels of a mark, numbered from 1 to nP, is entered. In step 51 examination if coordinate (x, y) of the pixels is inside the edition-frame 20 takes place as described above. If this is the case, the pixel is erased by setting its color code to TF, the background color (equals to 0 in the example), thus writing the value TF to the second column of the dynamic list 22, shown in FIG. 5. Let T(x, y) equal TF. Step 52 is not executed if the coordinates of the pixel are not laying outside of the edition-frame 20. Then the final steps of the loops 53 and 54 are executed, which increment the indices of the loop by 1, and the new frame where the initial character have been erase is redrawn in step 55.

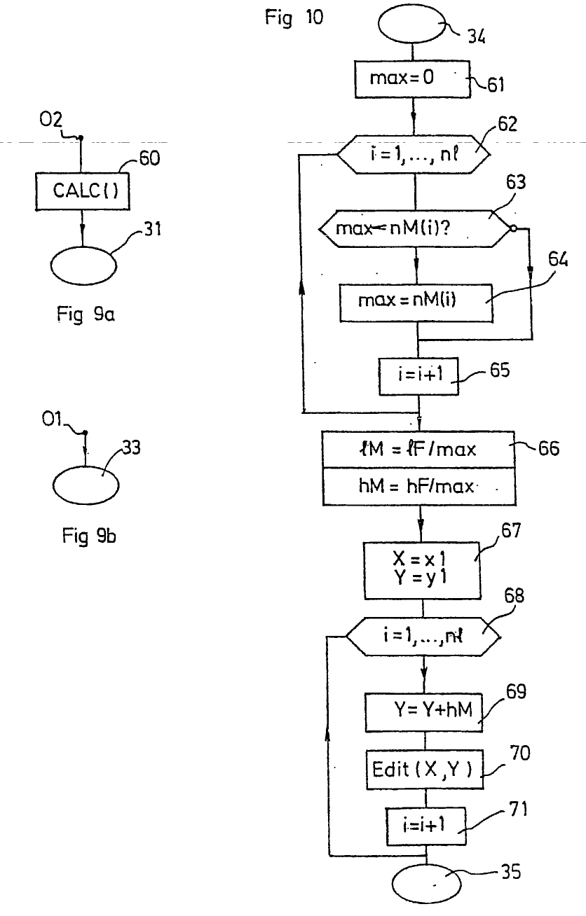

The source input operation allows obtaining edited characters from a digital data processing program like a spreadsheet or a text-editor. The edition function of this operation is the same as the function used in the user input operation, which has been described above, therefore all initial characters within the edition-frame 20 are erased in advance. See the flow-chart at the edition function of point O1, shown in FIG. 6b in order to create a new frame B[n−1] in which the obtained values, that are the output of the numerical data processing program and represented by the function EXTERN (B(n+1)) during step 58 of FIG. 8 are used. in the next step 59, a new step of the numerical data processing with the aide of a spreadsheet or text-editor is invoked, in order to obtain the edited characters that are to be inserted in the edition-frame 20.

The operation of application edition allow to the user to display and introduce the results of a calculation, like price per article or taxes, done by a digital data processing program at a chosen place of the edition-frame 20 and to draw it to the image of that frame. For the editing function of the operation (FIG. 9a), in an initial step the initial characters within that frame are erased, hence starting from Q2 of the flow-chart in FIG. 7a, before the new image DN is created during step 55. From that point on the result of the calculation done by the digital data processing program is drawn to a new frame in step 60. The function then exits. During this operation, no particular edition is done in a way the edition function (FIG. 9b) resumes with Q1 of the flow-chart in FIG. 6b, final step 33.

FIG. 12d represents an example of a frame obtained by a spreadsheet during source edition. The spreadsheet program has in fact modified the initial character “5” to an edited character “6”, and allowed to add the edited characters “8” and “9”. In the next step of FIG. 12e, the editing function erases all initial characters of the edition-frame 20, represented in FIG. 12a. By combining their values in FIG. 12d with the image of FIG. 12e, created during step 55, a final new image DN, represented by FIG. 12f, can be obtained. Obviously, these initial characters, even if erased from the image, can be reintroduced in their initial form to the frame. In fact, their pixels are still memorized in the dynamic list 22.

In the second variant, represented by FIG. 3, the configuration menu is preprogrammed to incorporate the different above-described operations on the edition-frame 20. For example, for a call to tender the edition-frames can correspond to a limited number of date which has to be edited, usually chosen in a list or articles, in the number of articles, the quantity of articles, the price par piece of an article, the amount per article and the total sum.

Under these conditions, the menu 28 may incorporate the required operations for data editing. For example the editing-frame declared to naturally correspond to a “designation” would be an operation if user-editing. An editing-frame, declared to correspond to a column of quantities would require the OCR-input operation, see source-editing if the values are issue of a program running in advance. An editing-frame declared as “amount per article” corresponds to a source-editing operation . . .

Of course the different operations of the main configuration menu 27 can be combined in a single editing-frame 20.

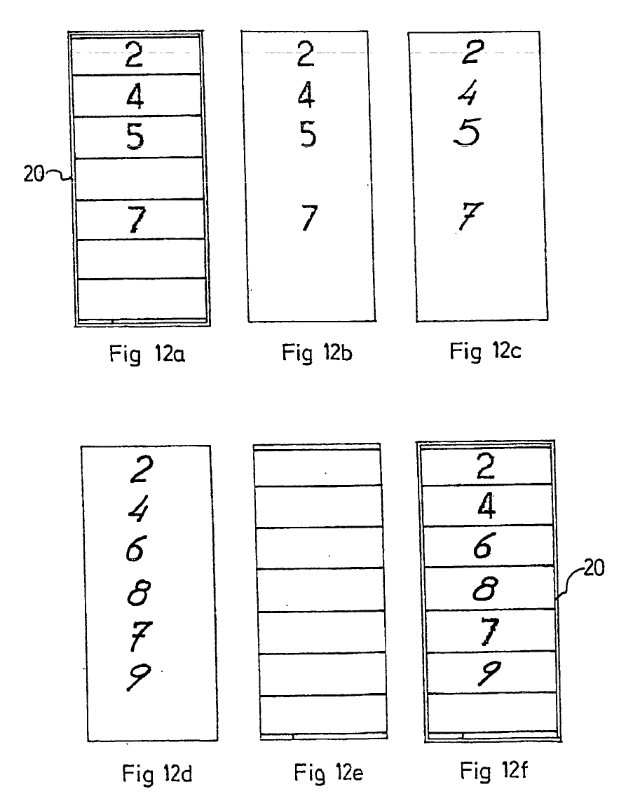

During the drawing of the new frame (step 55), the program of the invention is adapted to automatically calculate the dimension of edited characters and their appropriate replacement, in a way that the invariable graphical subsets are not overlaying. This is done according to the flow-chart in FIG. 10 which contains an initial step 34, a step 61 where a parameter called max is initialized to 0, a step 62 where a loop is entered, that covers the individual lines, numbered from 1 to nl within the edition-frame 20. The number of lines nl can be entered by the user or be calculated by the program, for example depending on the amount of space between the initial character M1 and the edition-frame 20, after the execution of a character recognition program, and/or depending on the number of invariable graphical subsets present in the edition-frame 20, as determined in the above-described step 42.

For each line, the parameter max is compared to the number nM(i) of initial characters on that line, during step 63. If it is inferior, the value of max is set to that of nM(i) in step 64. If superior, step 64 is skipped and the loop is terminated in step 65. At the end of that loop, the value of max equals to the number of initial characters in the longest line of the edition-frame 20.

During step 66, the width lM and the height hM of each edited character is formulated:

lM=lF/max,

hM=hF/nl,

Where lF is the width of the edition-frame 20, and If is its height, measured in pixels.

Then the placement of the coordinates (X, Y) where the edited characters are to be drawn. First, during step 67, initialization X=x1 and Y=y1 to the coordinates of the upper-left corner of the edition-frame 20. Then a loop over the number of lines, numbered 1 to nl, is entered during step 68, where for every line Y is incremented by hM during step 69. Then the edited characters are altered on the current line during step 70, beginning at the placement of the coordinates (X, Y). Step 71 terminates the loop and therefore all lines that have to be edited. The process terminates with step 35.

The calculation of the dimension and the placements is automatically done each time the characters are drawn. This is particularly the case during step 55, the above-mentioned operation of user editing.

FIG. 13 represents an example of a filled printed document of to the invention. In that figure, the edited characters are written in italic, in order to distinguish them from the initial characters, represented in FIG. 2. Of course, such a distinction is not mandatory. It may furthermore be easily realized when the characters are edited in the invention, with the aid of every character-edition function. For example the CEdit class of MICROSOFT (R)'s library MFC. Thereby a filled image 80, onto which the edited characters are automatically positioned with the appropriate dimensions, into the adept zones, without the risk of overlapping or loss of invariable graphical subsets. The different edition-frames 20 that are opened to fill that image are marker with dotted lines. This filled image 80 may be directly printed, stored on storage-media, or transmitted through computer-networks, for example in an encrypted way.

The invention therefore allows good usability for the filling of printed documents of any sort in a very quick and easy way. Note that it allows the filling of empty documents that lack any calculations with a simple manual-editing, or the filling of more complex printed documents which incorporate calculations that may have been preprogrammed by one or more spreadsheet- or text-editor-programmers, as in the example of a call to tender.

The invention can be the subject of many variations relative to the currently described realization types. The functions, operations and steps described above may be realized by programming, for example using C++ language, under the WINDOWS (R) platform. Furthermore other operating systems or pointer-software may be used, than those commercialized by MICROSOFT CORPORATION. Also, the invention can be applied to other image formats that pixelised imaged, for example vectorized images, by adapting the corresponding algorithms in a manner that allows identifying the invariable graphical subsets.

1/ —Device for automated filling of printed documents containing marks with the aid of a computer—note that those may contain frames, borders, lines, columns, patterns, markers, signs, graphics, alphanumerical characters or signs, . . . —where contained characters have to be edited, this device and method incorporating a computer that is configured and adapted to:
allow the memorization and displaying on a screen (5) of an image called initial image (12), representing a printed document that is to be filled,
automatically identify the corresponding marks in the initial image (12),
allow the creation of at least one edition-frame (20), which covers a partial zone of the printed document in which at least one character is to be edited,
automatically identify, in each edition-frame (20), each of the subsets of the initial images, which are called invariable graphical subsets (M1),
corresponding to marks that extend into the edition-frame (20), but have at least 1 dimension that is superior to a predetermined value and/or inferior to another predetermined value.

2/ —Device of claim 1, comprising invariable graphical subsets (M1) that correspond to marks which extend more than the edition-frame (20) in at least one dimension.

3/ —Device of claim 2, comprising invariable graphical subsets (M1) corresponding to marks which extend over the limits of the edition-frame (20).

4/ —Device of one of the claims 1 to 3, comprising a computer that is configured and programmed in order to:
allow the activation of tools adapted for the edition of characters in order to allow the edition of at least one character, called edited character, and able to place it automatically at a predetermined point of the edition-frame,
automatically modify each subset of the original image (12) within the edition-frame (20) covered by at least one edited character, with the exception of invariable graphical subsets (M1), which remain unchanged, and thereby generate an image which is called filled image (80) of the printed document.

5/ —Device of one of the claims 1 to 4, comprising a computer which is configured to automatically identify in each edition-frame (20) each of those subsets of the initial image (12) which have a different color that a predetermined color, called background color.

6/ —Device of one of the claims 1 to 5, comprising a computer that is configured to automatically identify in each edition-frame (20), each of those subsets of the initial image (12), called initial characters (M2), corresponding to a mark that lies entirely within the edition-frame (20) and is not identified as invariable graphical subset (M1).

7/ —Device of the claim 6, comprising a computer that is configured and programmed to automatically modify each subsets of the initial image (12) within the edition-frame (20), by eliminating the invariable graphical subsets (M1) and conserving the initial characters (M2).

8/ —Device of the claim 4 and one of the claims 6 or 7, comprising a computer which is configured to modify the image of the edition-frame (20) in order to create the filled image (80), automatically erase at least every of the initial characters (M2) that would be at least partially covered by an edited character, within the edition-frame (20).

9/ —Device of the claim 7 or 8, comprising a computer, which is able to attribute each initial character (M2) with a memorized identification code, according to its family of predetermined object-forms, where the computer is adapted and programmed to execute a character recognition program at least for every initial character (M2) identified within at least one edition-frame (20).

10/ —Device of one of claims 1 to 9, comprising a computer that incorporates at least one digital data processing program, chosen among a spreadsheet, a text-editor a image-editor, configured according to predetermined conditions that are imposed by the printed document which has to be filled, tools to allow the user to associate each edition-window to an input or output interface of a computer-program, and that the computer is adapted to define data as edited characters generated by this computer-program.

11/ —Device of one of the claims 1 to 10, comprising the fact of the initial image (12) being a digital pixelised image, where the computer incorporates tools for analysis of the initial image (12) which are adapted to automatically generate a dynamic list (22) of all marks in the initial image (12), each mark of that list (22) being formed by a single set of adjacent pixels, selected according to their coordinates and have a color code which satisfies at least one predetermined condition.

12/ —Device of claim 11, comprising the tools for analyzing the initial image (12) which incorporate means sorting and/or filtering adapted to automatically generate an image (23) from the initial image (12), in which the colors are members of a palette with a predetermined number of colors, one of those colors corresponding to the background color of the image, and each mark in the list (22) being a set of adjacent pixels that have a color code which is different from the background color.

13/ —Device of one of the claims 11 or 12, comprising the step of each mark in list (22) being formed by a set of adjacent pixels which have the same color code.

14/ —Device according to one of claims 11 to 13, comprising a computer which is configured to automatically compare the coordinates of the pixels in each mark of list (22) with those of pixels within a edition-frame (20), in order to automatically determine if one of them is within that edition-frame (20), and, if that is the case, to automatically determine if there exist pixels of that same mark, which have coordinates exceeding predetermined limits—usually outside the edition-frame (20)—in a way that this mark is identified as invariable graphical subset (M1).

15/ —Device of claim 14, comprising a computer that is configured to automatically compare the coordinates of the pixel in each mark of list (22) with those of pixels contained in a edition-frame (20), in order to automatically determine if one of them is part of the edition-frame (20), and, if the case, to determine automatically if all the pixels of that mark have coordinates included within predefined limits—usually those of the edition-frame (20)—in order to identify that mark as being an initial character (M2).

16/ —Device of the claims 14 and 15, comprising a computer that is configured to automatically examine each mark of list (22), and,
if it is identified as being an invariable graphical subset (M1), not applying any character recognition program to this mask
if it is identified as initial character (M2), applying automatically a program of character recognition.

17/ —Device of one of the claims 11 to 16, comprising a computer which is configured to automatically conserve or incorporate the pixels of the marks in list (22) that correspond to invariable graphical subsets (M1) and initial characters (M2) that have not been edited to the filled image (80).

18/ —Device of one of the claims 1 to 17, comprising a computer, which is configured to automatically calculate the dimensions of each edited character, in order to render them compatible with the invariable graphical subsets (M1) and the edition-frame (20) and in order to place it correctly into the filled image (80).

19/ —Device of one of the claims 1 to 18, comprising a computer that is configured and programmed to activate tools for character edition upon command from a pointer-program (mouse driver) which is guided by the user to a predetermined point in a edition-frame (20) of the initial image (12), used to place at least one edited character.

20/ —Device of one of the claims 1 to 19, comprising a computer being configured and programmed to allow the definition of each edition-frame (20) by the user using a pointer-program and a graphical user interface.

21/ —Device of one of the claims 1 to 20, comprising a computer being configured to allow the reproduction of the filled image (80) in stable form—usually by printing or writing to read-only storage-media.

22/ —In a device comprising a computer with at least one screen (5) for electrical display, a method for automated, computer-aided filling of printed documents which contain marks, usually containing frames, borders, lines, columns, patterns, markers, signs, alphanumerical or graphical signs, . . . and in which the characters are to be edited, this method containing the steps:
display of the image, called initial image (12), on a screen (5), representing a printed document,
identifying automatically, in each edition-frame (20) that has at least one character requiring edit, each individual subset of the initial image, which are called invariable graphical subsets,
defining, within this initial image (12), at least one frame, called edition-frame, covering a partial zone of the printed document, in which at least one character is to be edited,
and identifying automatically, within each edition-frame (20), each of the subsets of the initial image, that are called invariable graphical subsets (M1), corresponding to the marks which extend into the edition-frame (20) and has at least one dimension which is superior to a predetermined value and/or inferior to another predetermined value.

23/ —Method of claim 22, comprising the steps of the invariable graphical subsets (M1) corresponding to mark which are superior to the size of the edition-frame in at least one dimension (20).

24/ —Method of claim 23, comprising invariable graphical subsets (M1) corresponding to marks which extend over the limits of the edition-frame (20).

25/ —Method of one of the claims 22 to 24, comprising the steps of:
activation of character-editing tools, which are configured to allow the edition of at least one character, called edited character, and able to place it on a predetermined point of at least one edition-frame (20) of the initial image (12),
automatically modifying each part of the initial image (12) within the edition-frame (20) covered by at least one edited character, with the exception of the invariable graphical subsets (M1) that remain unchanged, and thereby generation of the image called filled image (80), of the printed document.

26/ —Method of one of the claims 22 to 25, comprising a step where the marks of the initial image, which are parts of the initial image (12) having a distinct and predetermined color, called background color, are automatically identified.

27/ —Method of one of the claims 22 to 26, comprising the steps of:
automated identification of each part of the initial image (12) within the edition-frame (20), which is called initial character (M2), corresponding to a mark which fits entirely into the edition-frame (20), and that is not identified to be an invariable graphical subset (M1).

28/ —Method of claim 27, comprising the steps of automated modification of each portion of the initial image (12) in which the edition-frame (20) by eliminating the invariable graphical subsets (M1) while preserving the initial characters (M2).

29/ —Method of claim 25 and of one of the claims 27 or 28, comprising the steps of consisting of modifying the initial image (12) in the edition-frame (20) in order to create the filled image (80) and to erase at least each of the initial characters (M2) from the edition-frame (20), which would have been partially covered by the edited character.

30/ —Method of one of the claims 26 to 29, comprising the step of a recognition being able to attribute each initial character (M2) with a identification code, that has been memorized from one of the form of one the objects in the family of known objects, depending on its form, in a way that this step of recognition is executed for at least the initial characters (M2) identified in at least one edition-frame (20).

31/ —Method of one of the claims 22 to 30, comprising the steps:
processing data that has been selected with a spreadsheet or text-editor, and a program for digital image processing, configured according to the predetermined conditions that are defined by the printed document that has to be filled,
associating to each edition-frame (20) an input and/or an output interface of a digital data processing program,
defining the data obtained from that program as edited characters.

32/ —Method of one of the claims 22 to 31, comprising the steps of:
memorization of the initial image (12) as digital pixelised image,
analyzing the initial image (12) and automatically generating a dynamic list (22) of all the marks in that initial image (12), where each mark in that list (22) is formed by a single set of adjacent pixels, selected according to their coordinates and having a color code satisfying to at least one predetermined condition.

33/ —Method of claim 32, comprising the steps of
sorting and/or filtering the initial image (12) in order to automatically generate, based of this initial image (12), an image (23) with colors that are part of a palette that contains a predetermined number of colors, among which is one color that corresponds to the background color of the image,
sorting each mark in the list (22) as a set of adjacent pixels having the same color code, which is unequal to the background color.

34/ —Method of one of the claims 32 to 33, comprising the fact that each element of the list (22) is being formed of an adjacent set of pixels, having the same color.

35/ —Method of one of the claims 32 to 34, comprising the steps of:
automated comparing of the coordinates of pixels from each mark in the list (22) with those of the pixels within the edition-frame (20),
determining automatically if one them is part of that edition-frame (20),
and, if so, determining automatically if pixels exist within that same mark, which are outside of predetermined bounds—usually outside of the bound of the edition-frame (20)—, in a way that enables to identify that mark as being an invariable graphical subset (M1).

36/ —Method of one of the claims 32 to 35, comprising the steps:
automatically comparing the coordinates of the pixels of each mark in the list with those of the pixels within an edition-frame (20),
determining automatically if all pixels of that mark have coordinates, which are within, predetermined limits—usually those of the edition-frame (20)—, in a way that enables to identify these marks as being initial characters (M2).

37/ —Method of the claims 35 and 36, comprising the steps of:
automated examination of each mark in the list (22), and,
if it is identified as being a invariable graphical subset (M1), not applying a character recognition program to that mark,
if it is identified as being an initial character (M2) however, applying automatically a character recognition program on that mark.

38/ —Method of one of the claims 32 to 37, comprising the steps:
automated conservation or incorporation of the pixels from marks, which correspond to invariable graphical subsets (M1) and to initial characters (M2) therefore not being subject of any editing, in the list (22) into the filled image (80).

39/ —Method of one of the claims 22 to 38, comprising the steps:
automated calculation of the dimension of each edited character, in order to render them compatible to the invariable graphical subsets (M1) and to the edition-frame (20), and in a way that the edited character is correctly positioned in the filled image (80).

40/ —Method of one of the claims 22 to 39, comprising the steps of:
activation of tools that enable to edit the characters up command from a pointer-program, guided by a user, at a predetermined point of the edition-frame (20) of the original image (12), starting from which at least one edited character should be positioned.

41/ —Method of one of the claims 22 to 40, comprising the steps of :
allowing defining each edition-frame (20) by the user, using a pointer-program and a graphical user interface.

42/ —Method of one of the claims 22 to 41, comprising at least one step in which the filled image (80) is reproduced under a stable form—usually by printing or writing to read-only storage-media.

43/ —Software product able to be loaded into the random access memory of a computer in order to realize a method of one of the claims 22 to 42, in a way that a device and method of one of the claims 1 to 21 is created.

44/ —Storage support that is adapted to be read by a drive that is connected to a computer, comprising the steps of containing a stored program that is configured to be loaded into the random access memory of a computer and program to be a method of one of the claims 22 to 45, in a way that a device and method of one of the claims 1 to 21 is created.
